(19) United States
(12) Patent Application Publication
(10) Pub. No.: US 2003/0172574 A1
(43) Pub. Date: Sep. 18, 2003

(54) Hunter's blind

(76) Inventor: Scott Drummond, Humphrey, AR (US)

Correspondence Address: Dennis B. Haase, Esq., Post Office Box 3592, Little Rock, AR, 72203, US

(21) Appl. No.: 10/094,920

(22) Filed: Mar. 12, 2002

(51) Int. Cl. A01M 1/00

(52) U.S. Cl. 43/1

(57) ABSTRACT

A hunter's blind which provides a hunter's chamber within a tubular body and having a cover with an opening therein, which opening is partially covered by an integrally formed hood which permits the hunter to have a panoramic view of the habitat and to rise, aim and shoot at prey within range without his or her activities creating visible motion which would otherwise disturb the prey.

The present invention relates generally to devices for visually concealing a hunter from game in the immediate vicinity, and, in particular, a device for literally housing the hunter either above or below ground level, or in the water, in a manner which permits the hunter to blend into the environment, rendering him or her essentially invisible from either ground level or from the air.

### BACKGROUND OF THE INVENTION

1. Field of the Invention

Hunting, whether for sport or food, was once a simple process of walking a habitat where a particular game, e.g., water fowl, was prevalent, and shooting, whether by firearm or bow, at the prey.

In modern times, hunting has evolved into a science, an integral part of which is deception. The hunter studies his prey, learning its habits, and employs camouflage, calling devices, strategically planted foods, and decoys to bring the prey within striking distance.

The prey, as the hunted over the years, has become familiar with the tricks of the hunter and has become wary of situations which appear suspicious. As a consequence, the hunter's patience is be constantly tried and tested.

In appreciation of the nature of the match of wits and instincts between the hunter and the hunted, the hunter has sought, and continues to seek, devices which will conceal his or her presence in the hunted's habitat, and such devices have become known to hunters simply as blinds.

2. Overview of the Prior Art

It is axiomatic that a blind has the primary purpose of concealing, or at least obscuring, the presence of a hunter(s). Not surprisingly, therefore, blinds come in a variety of shapes and sizes which emulate things such as hay bales, which are indigenous to the environment, and, typically, include some form of camouflage.

Reference is made initially to the Macks Prairie Wings® Catalogue, Fall 2001-2002 edition, at pages 32 and 36, where blinds of this type are illustrated. Similar illustrations are also found in Cabela's Master Catalog, Fall 2001, at pages 427 and 509.

Still others have patented their blinds, e.g., Smith, in his Pat. No. 3,513,605, which teaches a cylindrical enclosure that is secured partially sub surface and provides an adjustable seat for the hunter, together with some additional creature comforts for the patiently awaiting hunter housed in the cylinder. The top, or lid, of Smith is swingably secured about a vertical pin and is rotated out of the way on the pin so that the hunter can stand and shoot.

Cardozo, in his Pat. No. 4,738,045, discloses a cylindrical enclosure, again mounted sub surface, and which the patentee refers to as a standard duck blind unit, the apparent patentable feature being the panels which comprise the cover over the standard blind, which are spring loaded to retract the panels when tapped by the hunter.

Caccamo Pat. No. 3,886,678 involves a duck blind wherein the top, or cover, is both spring loaded and operated by a foot treadle, manually actuated by the hunter to raise a camouflage cover.

Ward, in his Pat. No. 5,822,906, takes a different approach. Ward provides a shell which places the hunter in the prone position, as though in a casket. The lid is segmented and provides gun ports. Camouflage is provided by the hunter and is not part of the unit. A similar theme is exhibited in Powlus U.S. Pat. No. 4,581,835, where the hunter is ensconced in a shell that is shaped to emulate a wild goose.

Finally, Webb in his Pat. No. 2,992,503 takes camouflage in a different direction by surrounding a cylindrical blind with a facade which gives the appearance of a tree stump. The top or cover is swingable to permit the hunter to stand and shoot.

While each of the blinds described is intended to enhance the hunting experience to a greater or lessor degree, each is saddled with a deficiency which limits its ability to achieve its goal, as will become apparent hereinafter.

### SUMMARY OF THE INVENTION

The present invention chronicles an innovative advance in hunter's blinds, in which the blind may be mounted in a variety of orientations ranging from simply sitting on the ground, where it provides an exceptionally stable base, to being mounted partially sub surface, or even in water, which is so prevalent in the wetlands areas frequented by ducks and geese.

This novel design incorporates ready ingress and egress, and for storage of such things as ammunition at the ready, and, further, has a cover which provides the hunter with a wide angle view of the sky and surrounding surface while in repose in the blind such that the hunter can squeeze off several shots without moving the lid or cover, movement of which would, in all likelihood, disturb incoming fowl, as well as frightening other fowl on the surface of the water or surrounding soil.

With the foregoing firmly in mind, it is a principal objective of the present invention to provide a hunter's blind which effectively disguises the presence of a hunter in the habitat of the prey, while permitting the hunter to view his surroundings and squeeze off one or more shots without alerting the prey to his or her presence until the weapon is discharged.

It is an objective of the present invention consonant with the other objectives thereof, to provide a blind of the type described in which the hunter may repose in relative comfort for extended periods of time.

Yet another objective is to provide such a blind in which necessities, such as ammunition, water, and the like, are readily stored out of the way so as not to be bumped or spilled by movement of the hunter in the blind while being close at hand for ready use as needed.

Another, and still further, object of the present invention is to provide a blind which permits the hunter to enter and leave the blind quickly and conveniently and without undue care for other objects such as seating within the enclosure.

The foregoing, as well as other objects and advantages of the present invention, will become apparent to those skilled in the art upon a reading of the Detailed Description of the Present Invention, taken in conjunction with the drawings, wherein:

### DESCRIPTION OF THE DRAWINGS

FIG. 1 is a pictorial representation of the hunter's blind of the present invention, illustrating how a hunter might rise to fire at prey from the blind;

FIG. 2 is a top plan view of the blind of the present invention, emphasizing various features of the cover for the blind;

FIG. 3 is a sectional view of the blind of FIG. 1, taken along section lines 3-3 of FIG. 2; and,

FIG. 4 is a figure similar, in perspective, to that of FIG. 1 and illustrating the interrelationship between the body of the blind of the present invention and the cover therefor.

### DETAILED DESCRIPTION OF A PREFERRED EMBODIMENT

With reference now to the drawings, and initially to FIG. 1, a hunter's blind, constructed in accordance with the present invention, is illustrated at 10. A hunter H is in the blind and has risen to fire at a prey (not shown) within the immediate surroundings of the blind, which is the habitat in which the prey would typically be expected to inhabit.

Still referring to FIG. 1, the blind 10 comprises a cylindrical barrel like body member 12; a base member 14, which, as shown, has a frustro conical configuration and a cover 16.

The main body member 12 is preferably constructed of a durable, non porous, moisture impermeable material, and any one of several suitable plastic materials are currently available. While other suitable materials will occur to those skilled in the art, it will be appreciated that the molding techniques currently known make plastic materials of exceptional value.

The body member 12, in keeping with the invention, is defined by groups of series of axially spaced, radially outwardly extending rings, all of which are disposed about a central longitudinal axis A. A larger diametral group of rings includes rings 21, 23 and 25. Interspersed between the larger group of rings 21, 23, and 25, and acting essentially as spacers, is a smaller grouping of rings comprised of rings 28, 30, 32, and 34. It will be appreciated that the rings 21, 23, and 25, as shown, are of the same diameter, and that rings 28, 30, 32, and 34 are similarly of the same diameter, having an upstanding outer diametral wall 35, but smaller as a group than the diameter of the rings comprising the larger group.

It will also be appreciated that the rings, as shown, are integrally formed, although it is conceivable that they could be individually formed and then connected in some well known manner to create the cylindrical body.

As shown, the ring 28 is adjacent the base member 14, while the ring 30 is disposed between rings 21 and 23, of the larger group, creating a spacing between those rings. Ring 32 is similarly disposed between larger rings 23 and 25, creating a space there between. Finally, ring 34 is disposed immediately below the cover 16 and defines the cup 36 which receives and seats the cover.

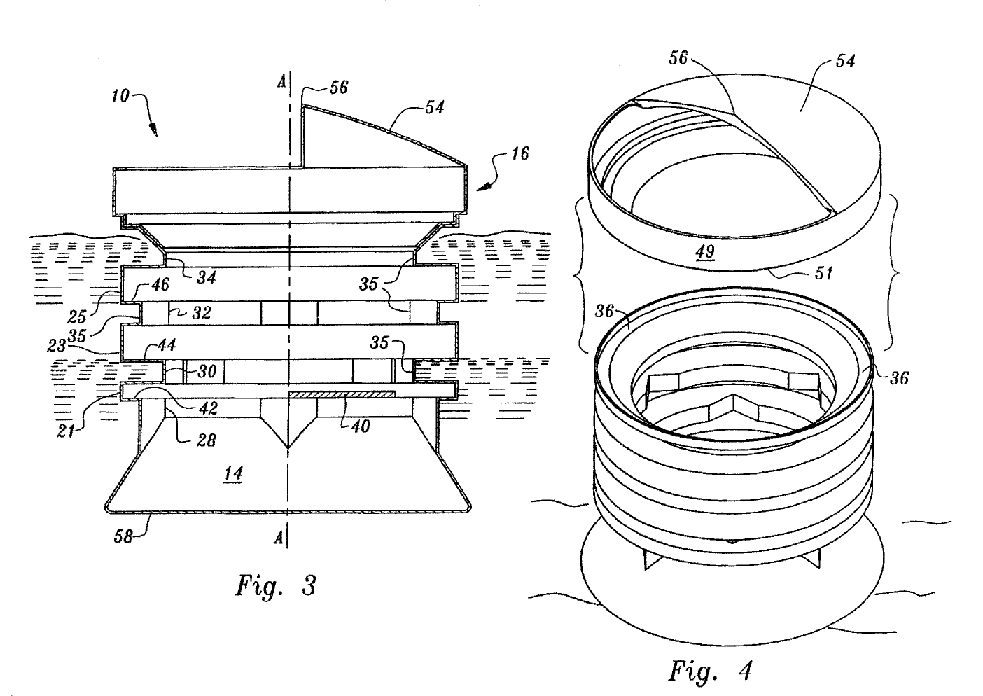

With particular reference now to FIG. 3, the chamber defined by the body member 12 may be clearly viewed. For example, a seat 40 is conveniently positioned on the shelf 42 defined by the surface of the ring 21, which is the lowest of the larger group of rings, and is just above the ring 28, which receives the base member 14.

The seat, at a minimum, comprises a board, which is of sufficient length to fit along a chord of the circular shelf 42, where it provides a solid and stable seating area for the hunter H while waiting for prey to enter the habitat.

The rings 23 and 25, in keeping with other objectives of the present invention, similarly define platforms, or shelves, 44 and 46, respectively. The platforms 44 and 46 provide convenient storage for such things as ammunition, water, food, reading materials, scopes, and any other thing which the hunter H may need, or desire, while he is within the chamber defined by the body member 12. In a similar fashion, the platforms, or shelves, are convenient steps which would permit the hunter to step into and out of the blind 10 with ease.

In keeping with other aspects of the invention, the cover 16 is uniquely constructed to provide the hunter H with an expansive, panorama view of the habitat in which the blind 10 is located,, and, once having cited prey within range, to rise and shoot without having to first lift, rotate or otherwise move the cover, thereby avoiding a movement which would alert the prey as to potential danger and frighten it away.

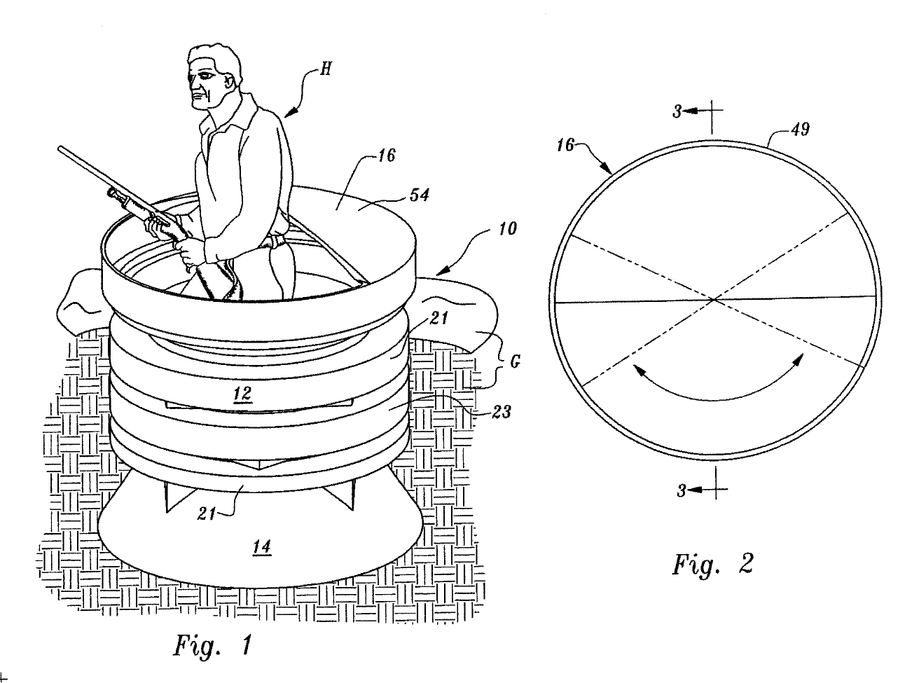

Thus, and with reference to FIGS. 2, 3 and 4, the cover 16 comprises a cylindrical ring 49, having a diameter which is compatible with the diameter of the body member 12. The ring defines an opening 52 in the cover 16. At the bottom thereof is a seat 51 which is dimensioned to snugly fit into the cup 36 at the top of the body member 12, while being capable of being manually rotated in the cup at the instance of the hunter H.

In order to provide the hunter with cover from prey above the blind 10, the cover is formed, or otherwise provided, with a hood, or cover, 54. The hood encompasses a portion, approximately half of the cover, as illustrated, although it may cover more or less of the cover without sacrifice to the objectives of the invention.

The hood 54 is raised at the center 56 thereof so as to present the hunter with the ability to view the habitat in a horizontal plane, thereby ensuring that the hunter will have an expansive view of the habitat from ground level to vertically above the blind without him or herself being observed by the prey, or causing the hunter to initiate movement which would alert his or her prey to the presence of potential danger.

As a result of the open nature of the cover with the raised hood, the hunter can quickly, and with a smooth motion, rise from the seat 40, aim and shoot at the prey he or she has observed within range.

As previously stated, the blind of the present invention is very stable, even with a large hunter within the chamber. In keeping with this aspect of the invention, the base 14, which supports the body member 12, is flared outwardly from its point of attachment to the body member 12 to its terminus 58. Accordingly, any movement by the hunter H is absorbed by the base so that neither the blind 10, nor its occupant are caused to be off balance.

It is important that the blind 10 not only be stable simply sitting on the ground or other surface, but be capable of being buried in the ground G, or even submerged to a substantial portion of its length in water. To this end, all joints, e.g., between the base member 14 and the body 12 are water tight. The blind is not buried or submerged so as to encompass the cover, so the seat between the body member 12 and the cover 16 need not be water tight, although it is evident that it could be if the necessity arose.

It has been found that some materials which would otherwise be acceptable for the manufacture of the blind of the present invention have a characteristic response to heat which would cause the body member to tend to settle if exposed to elevated ambient temperatures which are not all together uncommon during hunting season. The resultant action is visually similar to the movement of the bellows of an accordion with the upstanding side walls of the various rings, i.e., the walls which parallel the longitudinal axis A-A of the body member, to buckle somewhat. In order, therefore, that such accordion action does not occur while a hunter is in situ, the outer diametral wall 35 is notched as at 60 which is preferably accomplished in the molding process, and adds strength to the side wall, which will inhibit the tendency of the body member 12 to buckle under the heat, thus providing additional stabilization.

Having thus provided a detailed description of a preferred embodiment and with the clear understanding that some variation in specific aspects of the structure will be anticipated by those skilled in the art without departure from the invention, what is claimed is:

1. A blind for occupancy by a hunter in relative obscurity while hunting, comprising, in combination:
a cylindrical body member; said body member being formed so as to define series of axially spaced, radially outwardly extending rings, said body member defining a chamber for concealing a hunter therein;
a cover, said cover comprising a ring, said ring defining an opening in said cover through which a hunter in said chamber can view the habitat about the blind.

2. The blind of claim 1, wherein a hood is provided, said hood covering at least a portion of said opening.

3. The blind of claim 1, wherein said rings serve as steps in said hunter's blind for ready ingress and egress to and from said chamber within said blind.

4. The blind of claim 1, wherein a seat is provided, said seat being supported by one of said rings.

5. The blind as described in claim 1, wherein said rings comprise two groupings, in which one said group has rings with an outer diameter which is greater than the other grouping, and members of said groupings are interspersed such that a ring of said one of said groupings is adjacent to a member of said other of said groupings.

6. The blind of claim 1, wherein said cover is disposed on said body member and is manually rotatable relative thereto in order to provide a panoramic view of the habitat in which said blind is situated.

7. The blind of claim 1, wherein a base member is provided, said base member being flared outwardly away from said body member to thereby support said body member against movement there within.

8. The blind of claim 5, wherein said larger diameter grouping having flat horizontal surfaces within said blind, said surfaces serving as shelving and steps at the instance of a hunter disposed therein.

9. The blind of claim 2, wherein at least a portion of said hood is raised above said ring.

10. The blind of claim 3, wherein said rings comprise two groupings, in which one said group has rings with an outer diameter which is greater than the other grouping, and members of said groupings are interspersed such that a ring of said one of said grouping is adjacent to a member of said other of said groupings.

11. The blind of claim 2, wherein said cover is disposed on said body member and is manually rotatable relative thereto in order to provide a panoramic view of the habitat in which said blind is situated.

12. The blind of claim 2, wherein a base member is provided, said base member being flared outwardly away from said body member to thereby support said body member against movement there within.

13. The blind of claim 2, wherein said larger diameter grouping having flat horizontal surfaces within said blind, said surfaces serving as shelving and steps at the instance of a hunter disposed therein.

14. The blind of claim 5, wherein said larger diameter grouping having flat horizontal surfaces within said blind, said surfaces serving as shelving and steps at the instance of a hunter disposed therein.

15. The blind of claim 2, wherein a seat is provided, said seat being supported by one of said rings.
